(19) United States
(12) Patent Application Publication
(10) Pub. No.: US 2010/0021668 A1
(43) Pub. Date: Jan. 28, 2010

(54) DOUBLE-SIDED PRESSURE-SENSITIVE ADHESIVE SHEET AND LIQUID-CRYSTAL DISPLAY

(75) Inventors: Daisuke Shimokawa, Ibaraki-shi (JP); Mutsumi Kobayashi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/518,132

(22) PCT Filed: Nov. 26, 2007
(86) PCT No.: PCT/JP2007/072774

§ 371 Date: Jun. 8, 2009

(30) Foreign Application Priority Data
Dec. 13, 2006 (JP) 2006-336075

(51) Int. Cl. B32B 3/10

(52) U.S. Cl. 428/40.2

(57) ABSTRACT

The invention relates to a double-sided pressure-sensitive adhesive sheet for use in fixing a liquid-crystal display module unit to a backlight unit in a liquid-crystal display, the double-sided pressure-sensitive adhesive sheet including at least one heat-peelable pressure-sensitive adhesive layer containing heat-expandable microspheres. According to the double-sided pressure-sensitive adhesive sheet of the invention, since the pressure-sensitive adhesive layer has high adhesiveness and a liquid-crystal display module unit can be tenaciously fixed to a backlight unit with the pressure-sensitive adhesive sheet, excellent adhesion reliability can be attained. Furthermore, since this pressure-sensitive adhesive sheet can be easily made peelable by a heat treatment, it has excellent suitability for reworking.

### TECHNICAL FIELD

The present invention relates to a double-sided pressure-sensitive adhesive sheet and a liquid-crystal display employing the sheet. More particularly, the invention relates to a double-sided pressure-sensitive adhesive sheet for use in fixing a liquid-crystal display module unit to a backlight unit in a liquid-crystal display (LCD) of the lighting/external-light dual type for use in applications such as cell phones and personal digital assistants (PDAs).

### BACKGROUND ART

In LCDs of the lighting/external-light dual type for use in cell phones or the like, a liquid-crystal display module unit is fixed to a backlight unit with a double-sided pressure-sensitive adhesive tape or sheet (hereinafter inclusively referred to as “double-sided pressure-sensitive adhesive sheet”) (see, for example, patent documents 1 to 5).

The step of fixing a liquid-crystal display module unit to a backlight unit is conducted mainly manually because the variety of unit shapes makes machine laminating difficult. There are hence cases where the units are laminated in a wrong position and must be separated from each other. There is the same necessity when quality failures such as, e.g., foreign-matter inclusion and optical defects have occurred in the laminating step. However, when it is attempted to separate units which have been fixed to each other with a conventional double-sided pressure-sensitive adhesive sheet having strong adhesive force, a strong stress is imposed on the liquid-crystal module unit and the backlight unit. There are hence cases where the separation results in deformation or breakage, and this has been a factor in loss. These problems are becoming more conspicuous with the recent trend toward size reduction and thickness reduction in LCDs.

As described above, there has been a desire for a double-sided pressure-sensitive adhesive sheet having satisfactory peelability for the purpose of attaining improved suitability for reworking (ease of disassembly) in the case where a laminating failure or the like has occurred. However, to obtain peelability by lowering adhesive force has been problematic because it results in reduced adhesion reliability and leads to a quality loss. Namely, suitability for reworking and adhesion reliability based on high adhesiveness have not been reconciled so far.

Patent Document 1: JP-A-2002-249741

Patent Document 2: JP-A-2002-23663

Patent Document 3: JP-A-2002-235053

Patent Document 4: JP-A-2004-59723

Patent Document 5: JP-A-2005-213282

### DISCLOSURE OF THE INVENTION

Accordingly, an object of the invention is to provide a double-sided pressure-sensitive adhesive sheet which is for use in fixing a liquid-crystal display module unit to a backlight unit in an LCD and which, even when laminating in a wrong position, foreign-matter inclusion or the like has occurred, enables the liquid-crystal display module unit and backlight unit to be separated from each other without receiving any stress and be reused.

Another object of the invention is to provide a liquid-crystal display obtained by fixing a liquid-crystal display module unit to a backlight unit with the double-sided pressure-sensitive adhesive sheet.

The present inventors have made intensive studies in order to accomplish those objects. As a result, it has been found that high adhesiveness and peelability can be achieved at the same time to attain the above-mentioned objects by using a double-sided pressure-sensitive adhesive sheet having a heat-peelable pressure-sensitive adhesive layer containing heat-expandable microspheres as a double-sided pressure-sensitive adhesive sheet for fixing a liquid-crystal display module unit to a backlight unit in an LCD. The invention has been thus completed. Furthermore, it has been found that a liquid-crystal display obtained by fixing a liquid-crystal display module unit to a backlight unit with the double-sided pressure-sensitive adhesive sheet produces the effect of facilitating recovery. The invention has been thus completed.

Namely, the invention relates to the following (1) to (9).
(1) A double-sided pressure-sensitive adhesive sheet for use in fixing a liquid-crystal display module unit to a backlight unit in a liquid-crystal display, the double-sided pressure-sensitive adhesive sheet comprising at least one heat-peelable pressure-sensitive adhesive layer containing heat-expandable microspheres.
(2) The double-sided pressure-sensitive adhesive sheet according to (1) above, which comprises the heat-peelable pressure-sensitive adhesive layer containing heat-expandable microspheres as one outermost layer and further comprises a pressure-sensitive adhesive layer containing no heat-expandable microsphere as the other outermost layer.
(3) The double-sided pressure-sensitive adhesive sheet according to (1) above, which further comprises a substrate, and wherein the heat-peelable pressure-sensitive adhesive layer containing heat-expandable microspheres is disposed as the outermost layer on each side of the substrate.
(4) The double-sided pressure-sensitive adhesive sheet according to (1) above, which further comprises a substrate and a rubbery organic elastic layer disposed between the substrate and the heat-peelable pressure-sensitive adhesive layer.
(5) The double-sided pressure-sensitive adhesive sheet according to any one of (1) to (4) above, which has a light-shielding layer and/or a reflective layer.
(6) The double-sided pressure-sensitive adhesive sheet according to (5) above, wherein the light-shielding layer and/or the reflective layer is the substrate, the rubbery organic elastic layer, the pressure-sensitive adhesive layer, or any other desired layer.
(7) The double-sided pressure-sensitive adhesive sheet according to (6) above, wherein the reflective layer is a white substrate or a white printed layer.
(8) The double-sided pressure-sensitive adhesive sheet according to (6) above, wherein the light-shielding layer is a black substrate or a black printed layer.
(9) A liquid-crystal display, which comprises a liquid-crystal display module unit and a backlight unit fixed with the double-sided pressure-sensitive adhesive sheet according to any one of (1) to (8) above.

According to the double-sided pressure-sensitive adhesive sheet of the invention, since the pressure-sensitive adhesive layer has high adhesiveness and a liquid-crystal display module unit can be tenaciously fixed to a backlight unit with the pressure-sensitive adhesive sheet, excellent adhesion reliability can be attained. Furthermore, since this pressure-sensitive adhesive sheet can be easily made peelable by a heat treatment, it has excellent suitability for reworking.

### BRIEF DESCRIPTION OF THE DRAWINGS

FIG. 1 is a diagrammatic sectional view illustrating one embodiment of the double-sided pressure-sensitive adhesive sheet of the invention.

FIG. 2 is a diagrammatic sectional view illustrating another embodiment of the double-sided pressure-sensitive adhesive sheet of the invention.

FIG. 3 is a diagrammatic view illustrating an arrangement of the liquid-crystal display module unit, backlight unit, and double-sided pressure-sensitive adhesive sheet in a liquid-crystal display according to the invention.

### DESCRIPTION OF THE REFERENCE NUMERALS

1 substrate

2 heat-peelable pressure-sensitive adhesive layer

3 pressure-sensitive adhesive layer containing no heat-expandable microspheres

4 separator

5 rubbery organic elastic layer

6 backlight unit

7 double-sided pressure-sensitive adhesive sheet

8 liquid-crystal display module unit

### BEST MODE FOR CARRYING OUT THE INVENTION

Embodiments of the invention are explained below in detail by reference to the drawings according to the necessity.

The double-sided pressure-sensitive adhesive sheet of the invention is a double-sided pressure-sensitive adhesive sheet having at least one heat-peelable pressure-sensitive adhesive layer containing heat-expandable microspheres. It may be a double-sided pressure-sensitive adhesive sheet of the substrate-based type which includes a substrate and pressure-sensitive adhesive layers formed respectively on both sides of the substrate. Alternatively, the pressure-sensitive adhesive sheet of the invention may be a double-sided pressure-sensitive adhesive sheet of the substrate-less type which includes only a pressure-sensitive adhesive layer. Of these, the double-sided pressure-sensitive adhesive sheet of the substrate-based type is more preferred from the standpoints of handleability, processability, etc. The double-sided pressure-sensitive adhesive sheet of the invention may have a pressure-sensitive adhesive layer containing no heat-expandable microsphere (adhesive layer of the pressure-sensitive type), a rubbery organic elastic layer, and other layers (e.g., an independent light-shielding layer, reflective layer, etc.) besides the heat-peelable pressure-sensitive adhesive layer and the substrate. The pressure-sensitive adhesive surfaces of the double-sided pressure-sensitive adhesive sheet of the invention may be protected with a separator (release liner) applied thereto, before being used.

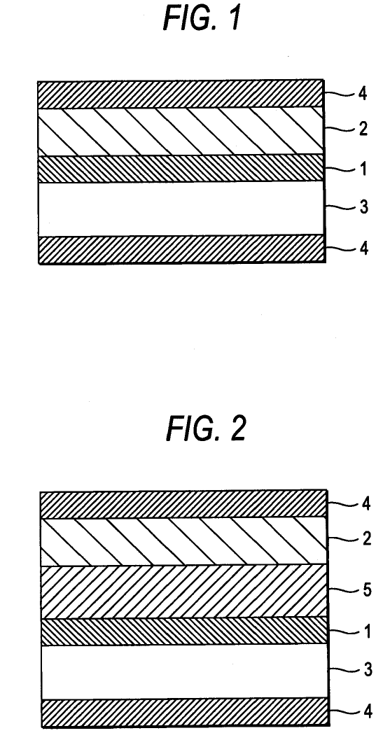

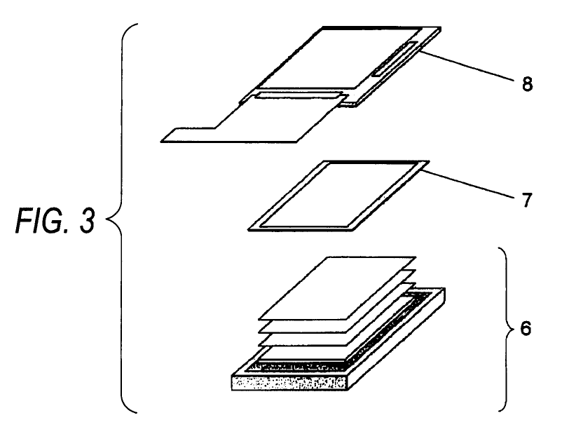

FIG. 1 and FIG. 2 are diagrammatic sectional views illustrating embodiments of the double-sided pressure-sensitive adhesive sheet (substrate-based type) of the invention. The embodiment shown in FIG. 1 includes a substrate 1, a heat-peelable pressure-sensitive adhesive layer 2 formed on one side of the substrate 1, and a pressure-sensitive adhesive layer 3 containing no heat-expandable microsphere and formed on the other side of the substrate 1, and further includes a separator 4 superposed on each pressure-sensitive adhesive layer. The embodiment shown in FIG. 2 includes a substrate 1, a heat-peelable pressure-sensitive adhesive layer 2 formed on one side of the substrate 1 through a rubbery organic elastic layer 5, and a pressure-sensitive adhesive layer 3 containing no heat-expandable microsphere and formed on the other side of the substrate 1. This embodiment further has a separator 4 superposed on each pressure-sensitive adhesive layer.

It is preferred that the double-sided pressure-sensitive adhesive sheet of the invention should have a reflective layer and/or a light-shielding layer. In particular, it is preferred that the pressure-sensitive adhesive sheet have at least a light-shielding layer. The reflective layer reflects the light emitted by a backlight to improve brightness and thereby produce the effect of reducing power consumption based on the effective utilization of light. On the other hand, the light-shielding layer prevents the light emitted by a backlight from leaking out to the liquid-crystal display module side and thereby has the effects of improving visibility and making boundaries on the liquid-crystal display screen clear. The reflective layer and the light-shielding layer may be formed as independent layers (e.g., ink layers or vapor-deposited layers). Alternatively, light-reflecting properties and/or light-shielding properties may be imparted to another layer, e.g., a substrate, to thereby form a reflective layer and/or a light-shielding layer. In the latter case, the reflective layer and/or the light-shielding layer can be the same as that layer, e.g., substrate.

### Substrate

In the case where the double-sided pressure-sensitive adhesive sheet of the invention is of the substrate-based type, the substrate is not particularly limited and any of various substrates can be used. For example, suitable thin sheet materials can be used and examples thereof include fibrous substrates such as fabrics, nonwoven fabrics, felts, and nets; paper substrates such as various papers; metallic substrates such as metal foils and metal sheets; plastic substrates such as films or sheets made of various resins; rubber substrates such as rubber sheets; foams such as foamed sheets; and laminates of these materials. Examples of the materials of the plastic substrates include polyesters (e.g., poly(ethylene terephthalate), poly(ethylene naphthalate), poly(butylene terephthalate), and poly(butylene naphthalate)), polyolefins (e.g., polyethylene, polypropylene, and ethylene/propylene copolymers), poly(vinyl alcohol), poly(vinylidene chloride), poly(vinyl chloride), vinyl chloride/vinyl acetate copolymers, poly(vinyl acetate), polyamides, polyimides, cellulose derivatives, fluororesins, polyethers, polystyrene resins (e.g., polystyrene), polycarbonates, and polyethersulfones. The substrate may have either a single-layer structure or a multilayer structure.

The thickness of the substrate is not particularly limited. However, from the standpoints of reduction in thickness and weight and of processability, the thickness thereof is preferably 4-70 μm, more preferably 10-50 μm.

The substrate in the invention may be a substrate having light-reflecting properties and/or light-shielding properties. In the case where the substrate is a black layer functioning as a light-shielding layer (light-shielding substrate) or a white layer or silver layer functioning as a reflective layer (reflective substrate), this substrate may contain a colorant which will be described later (e.g., black colorants, white colorants, and silver colorants) according to the color of the layer. In the case where the substrate is neither a black layer functioning as a light-shielding layer (light-shielding substrate) nor a white layer or silver layer functioning as a reflective layer (reflective substrate), this substrate preferably is one having transparency (transparent substrate).

The surface of the substrate may have undergone an ordinary surface treatment for enhancing adhesion to the heat-peelable pressure-sensitive adhesive layer, etc. according to need. Examples of the surface treatment include chemical or physical oxidation treatments such as chromic acid treatment, exposure to ozone, exposure to a flame, exposure to a high-tension electric shock, and treatment with an ionizing radiation.

It is preferred that the substrate to be used in the invention be a highly bondable substrate among those substrates, such as a substrate made of a highly polar polymer, e.g., a polyester, or a substrate whose surfaces have undergone, e.g., any of those oxidation treatments.

### Rubbery Organic Elastic Layer

The double-sided pressure-sensitive adhesive sheet of the invention may include a rubbery organic elastic layer disposed between the substrate and the heat-peelable pressure-sensitive adhesive layer. The rubbery organic elastic layer has the following functions. When the double-sided pressure-sensitive adhesive sheet is applied to an adherend, the elastic layer functions to enable the surface of the pressure-sensitive adhesive sheet to satisfactorily conform to the surface shape of the adherend and thereby have an increased adhesion area. When the pressure-sensitive adhesive sheet is to be separated from the adherend with heating, the elastic layer functions to highly (precisely) regulate the thermal expansion of the heat-peelable pressure-sensitive adhesive layer (heat-expandable layer) and enable the heat-peelable pressure-sensitive adhesive layer to evenly expand preferentially in the thickness direction.

From the standpoint of imparting those functions, it is preferred that the rubbery organic elastic layer be formed from natural rubber, a synthetic rubber, or a synthetic resin having rubber elasticity which each have a Shore D hardness in accordance with ASTM D-2240 of 50 or lower, especially 40 or lower.

Examples of the synthetic rubber or synthetic resin having rubber elasticity include synthetic rubbers such as nitrile, diene, and acrylic rubbers; thermoplastic elastomers such as polyolefins and polyesters; and synthetic resins having rubber elasticity, such as ethylene/vinyl acetate copolymers, polyurethanes, polybutadiene, and flexible poly(vinyl chloride). Incidentally, even an intrinsically rigid polymer such as, e.g., poly(vinyl chloride) can exhibit rubber elasticity when used in combination with a compounding agent such as a plasticizer or softener. Such a composition also can be used as a constituent material for the rubbery organic elastic layer. Furthermore, materials such as pressure-sensitive adhesive substances, e.g., a pressure-sensitive adhesive for constituting the heat-peelable pressure-sensitive adhesive layer which will be described later, can also be advantageously used as a material for constituting the rubbery organic elastic layer. Incidentally, the rubbery organic elastic layer and the pressure-sensitive adhesive layer containing no heat-expandable microsphere may have completely the same composition. In this case, the layer which is a surface layer in the double-sided pressure-sensitive adhesive sheet is defined as a pressure-sensitive adhesive layer, while the layer which is not a surface layer but an inner layer (especially one located between the substrate and the heat-peelable pressure-sensitive adhesive layer) is defined as a rubbery organic elastic layer.

The thickness of the rubbery organic elastic layer is generally 500 μm or smaller (e.g., 1-500 μm). In the case where the double-sided pressure-sensitive adhesive sheet is for use in a thin small liquid-crystal display for, e.g., a cell phone, the thickness of the layer is preferably 10-50 μm from the standpoint of reducing thickness and weight.

The rubbery organic elastic layer usually is transparent. However, in the case where the elastic layer is a black layer functioning as a light-shielding layer or a white layer or silver layer functioning as a reflective layer, this layer may contain a colorantswhich will be described later (e.g., black colorants, white colorants, and silver colorants) according to the color of the layer, like the substrate described above.

For forming the rubbery organic elastic layer, a suitable method can be used. Examples thereof include: a method in which a coating fluid containing the elastic-layer-forming material, e.g., natural rubber, a synthetic rubber, or a synthetic resin having rubber elasticity, is applied to a substrate (coating method); a method in which either a film made of the elastic-layer-forming material or a multilayer film obtained by forming a layer of the elastic-layer-forming material on one or more heat-peelable pressure-sensitive adhesive layers beforehand is bonded to a substrate (dry laminating method); and a method in which a resin composition containing a constituent material for a substrate and a resin composition containing the elastic-layer-forming material are co-extruded (co-extrusion method). The heat-peelable pressure-sensitive adhesive layer and the pressure-sensitive adhesive layer containing no heat-expandable microsphere, both of which will be described later, can also be formed by the same methods.

The rubbery organic elastic layer may be made of a pressure-sensitive adhesive substance including natural rubber, a synthetic rubber, or a synthetic resin having rubber elasticity as a main component. Alternatively, the rubbery organic elastic layer may be constituted of a foamed film or the like which is made mainly of that component. Foaming can be conducted by an ordinary method such as a method based on mechanical agitation, a method in which a gas evolved by reaction is used, a method in which a blowing agent is used, a method in which a soluble substance is removed, a method in which spraying is used, a method in which a syntactic foam is formed, or a sintering method. The rubbery organic elastic layer may have a single-layer structure or be constituted of two or more layers.

### Heat-Peelable Pressure-Sensitive Adhesive Layer

The double-sided pressure-sensitive adhesive sheet of the invention has at least one heat-peelable pressure-sensitive adhesive layer. The heat-peelable pressure-sensitive adhesive layer in the invention includes a pressure-sensitive adhesive for imparting pressure-sensitive adhesiveness and heat-expandable microspheres (microcapsules) for imparting thermal expansibility. Since the heat-expandable microspheres foam and/or expand upon heating, the heat-peelable pressure-sensitive adhesive layer comes to have a reduced area of adhesion between the adherend and the pressure-sensitive adhesive layer and hence abruptly decreases in adhesive force, and the pressure-sensitive adhesive sheet thus can be easily peeled off. Accordingly, the pressure-sensitive adhesive sheet in an unheated state retains high adhesiveness and, when desired to be peeled off, can be made easily peelable by heating, so that the pressure-sensitive adhesive sheet is excellent also in suitability for reworking. Incidentally, if a blowing agent which is not in the form of microcapsules is used, satisfactory peelability cannot be stably imparted.

It is preferred that the heat-peelable pressure-sensitive adhesive layer according to the invention be a surface layer (outermost layer) in the double-sided pressure-sensitive adhesive tape, i.e., be located in an outermost position. However, the layer may be located not as an outermost layer but as an inner layer. In such a case, this layer is a heat-peelable pressure-sensitive adhesive layer according to the invention so long as it is a layer containing heat-expandable microspheres and having the function of imparting heat peelability to an outermost layer of the tape.

The pressure-sensitive adhesive preferably is one which, during heating, restrains the foaming and/or expansion of the heat-expandable microspheres as less as possible. As the pressure-sensitive adhesive can be used one of or a combination of two or more of known pressure-sensitive adhesives such as, for example, rubber-based pressure-sensitive adhesives, acrylic pressure-sensitive adhesives, vinylalkyl ether type pressure-sensitive adhesives, silicone pressure-sensitive adhesives, polyester type pressure-sensitive adhesives, polyamide type pressure-sensitive adhesives, urethane type pressure-sensitive adhesives, styrene/diene block copolymer type pressure-sensitive adhesives, and pressure-sensitive adhesives having improved creep characteristics obtained by incorporating a heat-meltable resin having a melting point of about 200° C. or lower into those pressure-sensitive adhesives (see, for example, JP-A-56-61468, JP-A-61-174857, JP-A-63-17981, and JP-A-56-13040). The pressure-sensitive adhesive may contain suitable additives besides a pressure-sensitive adhesive ingredient (base polymer). Examples of the additives include crosslinking agents (e.g., polyisocyanates and melamine alkyl ethers), tackifiers (e.g., rosin derivative resins, polyterpene resins, petroleum resins, and oil-soluble phenolic resins), plasticizers, fillers, and antioxidants.

In general, the pressure-sensitive adhesive to be used is: a rubber-based pressure-sensitive adhesive containing natural rubber or any of various synthetic rubbers as a base polymer; an acrylic pressure-sensitive adhesive containing as a base polymer an acrylic polymer (homopolymer or copolymer) formed from one or more of alkyl esters of (meth)acrylic acid (e.g., C₁₋₂₀ alkyl esters such as the methyl ester, ethyl ester, propyl ester, isopropyl ester, butyl ester, isobutyl ester, s-butyl ester, t-butyl ester, pentyl ester, hexyl ester, heptyl ester, octyl ester, 2-ethylhexyl ester, isooctyl ester, isodecyl ester, dodecyl ester, tridecyl ester, pentadecyl ester, hexadecyl ester, heptadecyl ester, octadecyl ester, nonadecyl ester, and eicosyl ester) as monomer ingredients; or the like.

The acrylic polymer may contain units derived from one or more other monomer ingredients copolymerizable with the alkyl esters of (meth)acrylic acid according to need so as to be modified in cohesive force, heat resistance, crosslinkability, etc. Examples of such monomer ingredients include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as hydroxyethyl(meth)acrylate, hydroxypropyl (meth)acrylate, hydroxybutyl(meth)acrylate, hydroxyhexyl(meth)acrylate, hydroxyoctyl(meth)acrylate, hydroxydecyl(meth)acrylate, hydroxylauryl(meth)acrylate, and (4-hydroxymethylcyclohexy)methyl methacrylate; sulfo-containing monomers such as styrenesulfonic acid, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid; (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; aminoalkyl(meth)acrylate monomers such as aminoethyl(meth)acrylate, N,N-dimethyl amino ethyl(meth)acrylate, and t-butylaminoethyl(meth)acrylate; alkoxyalkyl(meth)acrylate monomers such as methoxyethyl(meth)acrylate and ethoxyethyl(meth)acrylate; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxamides, styrene, α-methylstyrene, and N-vinylcaprolactam; cyanoacrylate monomers such as acrylonitrile and methacrylonitrile; epoxy-containing acrylic monomers such as glycidyl(meth)acrylate; glycol acrylate monomers such as polyethylene glycol(meth)acrylate, polypropylene glycol(meth)acrylate, methoxyethylene glycol(meth)acrylate, and methoxypolypropylene glycol(meth)acrylate; acrylic ester monomers having a heterocycle, one or more halogen or silicon atoms, or the like, such as tetrahydrofurfuryl(meth)acrylate, fluoro(meth)acrylates, and silicone(meth)acrylates; polyfunctional monomers such as hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy acrylates, polyester acrylates, and urethane acrylates; olefin monomers such as isoprene, butadiene, and isobutylene; and vinyl ether monomers such as vinyl ether. One or more of these monomer ingredients can be used.

From the standpoint of a balance between moderate adhesive force before a heat treatment and the property of decreasing in adhesive force through the heat treatment, a more preferred pressure-sensitive adhesive is a pressure-sensitive adhesive containing a polymer which, in the temperature range of from room temperature to 150° C., has a dynamic modulus of elasticity in the range of from 50,000 to 10,000,000 dyn/cm² as a base.

The heat-expandable microspheres to be used in the heat-peelable pressure-sensitive adhesive layer in the invention may be microspheres obtained by enclosing in elastic shells a substance which readily gasifies and expands upon heating, such as, e.g., isobutane, propane, or pentane. The shells are frequently formed from a heat-meltable substance or a substance which breaks upon thermal expansion. Examples of such substances for forming the shells include vinylidene chloride/acrylonitrile copolymers, poly(vinyl alcohol), polyvinylbutyral, poly(methyl methacrylate), polyacrylonitrile, poly(vinylidene chloride), and polysulfones. The heat-expandable microspheres can be produced by a common method, e.g., the coacervation method or interfacial polymerization method. As the heat-expandable microspheres may be used a commercial product such as trade name “Microsphere F30D” or “Microsphere F50D”, each manufactured by Matsumoto Yushi-Seiyaku Co., Ltd., or trade name “Expancel 461-40DU”, manufactured by Japan Fillite Co., Ltd.

From the standpoint of efficiently reducing the adhesive force of the pressure-sensitive adhesive layer through a heat treatment, heat-expandable microspheres having such moderate strength that they do no break until the volume expansion ratio reaches 5 or higher, especially 7 or higher, in particular 10 or higher.

The amount of the heat-expandable microspheres to be incorporated can be suitably determined according to the expansion ratio of the pressure-sensitive adhesive layer, the property of decreasing in adhesive force (bonding strength), etc. In general, however, the amount thereof is, for example, 1-200 parts by weight, preferably 10-160 parts by weight, more preferably 30-80 parts by weight, per 100 parts by weight of the base polymer (e.g., acrylic polymer in the case of an acrylic pressure-sensitive adhesive) for forming the heat-peelable pressure-sensitive adhesive layer. When the heat-expandable microspheres are incorporated in an amount smaller than 1 part by weight, there are cases where the pressure-sensitive adhesive layer cannot have sufficient peelability. When the microspheres are incorporated in an amount exceeding 200 parts by weight, these are cases where adhesiveness decreases. In particular, it is sufficient in the invention that a member to be stripped off (adherend) can be separated easily in such a degree as not to break. In the case where a thin heat-peelable pressure-sensitive adhesive layer is to be formed, it is preferred that the amount of the heat-expandable microspheres to be incorporated be reduced in some degree. This is because such a reduced microsphere amount facilitates the stable formation of a surface state. From this standpoint, an amount (30-80 parts by weight) about a half of the amount necessary for complete separation (i.e., for reducing adhesive force to zero) is optimal.

The thermal-expansion initiation temperature of the heat-peelable pressure-sensitive adhesive layer in the invention is suitably determined according to the heat resistance of members used in the liquid-crystal display module unit and backlight unit in a liquid-crystal display, etc., and is not particularly limited. However, the thermal-expansion initiation temperature is generally 70-160° C., preferably 75-110° C., more preferably 90-100° C. When the thermal-expansion initiation temperature of the pressure-sensitive adhesive layer is lower than 70° C., there are cases where this pressure-sensitive adhesive layer suffers thermal expansion and a decrease in adhesive force when the LCD is exposed to a high-temperature environment as in applications such as cell phones, resulting in reduced adhesion reliability in high-temperature environments. When the thermal-expansion initiation temperature of the pressure-sensitive adhesive layer exceeds 160° C., it is necessary in reworking that the LCD should be heated to a high temperature in order to make the pressure-sensitive adhesive layer easily peelable. There are hence cases where members of the backlight unit or other members suffer thermal deformation, etc. and become unsuitable for reuse. The term “thermal-expansion initiation temperature” as used in the invention means such a minimum temperature that when the pressure-sensitive adhesive sheet is heated at that temperature for 1 minute, a decrease in adhesive force of 50% or more can be ascertained.

The thermal-expansion initiation temperature can be suitably regulated in accordance with the kind and particle diameter distribution of the heat-expandable microspheres, etc. In particular, it is effective to impart by classification a narrow particle diameter distribution to the heat-expandable microspheres to be used. For the classification, a known method can be used, and either a dry or a wet method may be used. As a classifier can be used a known classifier such as a gravity classifier, inertial classifier, or centrifugal classifier.

The thickness of the heat-peelable pressure-sensitive adhesive layer is preferably 300 μm or smaller (e.g., 1-300 μm), and is more preferably 10-50 μm from the standpoint of reducing the thickness and weight of LCDs for, e.g., cell phones. When the thickness thereof is too large, there are cases where a separating operation after a heat treatment is apt to result in a cohesive failure to cause the pressure-sensitive adhesive to partly remain on the adherend and foul the adherend. Namely, suitability for reworking decreases. On the other hand, when the thickness of the pressure-sensitive adhesive is too small, there are cases where the degree of deformation of this heat-peelable pressure-sensitive adhesive layer by a heat treatment is low and adhesive force is less apt to decrease smoothly or where it is necessary to add heat-expandable microspheres having an excessively small particle diameter.

In the case where the heat-peelable pressure-sensitive adhesive layer is a black layer functioning as a light-shielding layer (light-shielding pressure-sensitive adhesive layer) or a white layer or silver layer functioning as a reflective layer (reflective pressure-sensitive adhesive layer), this layer may contain a colorant which will be described later (e.g., black colorants, white colorants, and silver colorants) according to the color of the layer, like the substrate described above.

### Pressure-Sensitive Adhesive Layer Containing No Heat-Expandable Microsphere

The double-sided pressure-sensitive adhesive sheet of the invention may include a pressure-sensitive adhesive layer containing substantially no heat-expandable microsphere (adhesive layer of the pressure-sensitive type) as a surface layer. The pressure-sensitive adhesive (adhesive of the pressure-sensitive type) ingredient for the pressure-sensitive adhesive layer is not particularly limited, and use may be made of those shown above as examples with regard to the rubbery organic elastic layer and heat-peelable pressure-sensitive adhesive layer.

The thickness of the pressure-sensitive adhesive layer is preferably 300 μm or smaller (e.g., 1-300 μm), and is more preferably 10-50 μm from the standpoint of reducing the thickness and weight of LCDs for, e.g., cell phones.

In the case where the pressure-sensitive adhesive layer is a black layer functioning as a light-shielding layer (light-shielding pressure-sensitive adhesive layer) or a white layer or silver layer functioning as a reflective layer (reflective pressure-sensitive adhesive layer), this layer may contain a colorant which will be described later (e.g., black colorants, white colorants, and silver colorants) according to the color of the layer, like the substrate described above.

### Reflective Layer

The reflective layer of the double-sided pressure-sensitive adhesive sheet of the invention is a layer which has the functions of reflecting the light emitted by a backlight to thereby improve brightness and reducing power consumption based on the effective utilization of light. Although the reflectance of the reflective layer is not particularly limited, it is preferably 60(%) or higher (60-100(%)), more preferably 70(%) or higher, especially preferably 80(%) or higher.

Examples of the reflective layer in the invention include a white layer having a white color and a silver layer having a silver color, and a white color having a white color can be advantageously used. The term white color as used for the white layer basically means a whitish color which has a value of L* defined in the L*a*b* color system of 75 or larger (75-100, preferably 80 or larger (80-100), more preferably 85 or larger (85-100)). The values of a* and b* defined in the L*a*b* color system each can be suitably selected according to the value of L*. For example, the values of a* and b* each are preferably in the range of from −10 to 10 (in particular, from −5 to 5), and each especially preferably are 0 or almost 0 (in the range of from −2 to 2).

The term silver color basically means a silvery color which has a value of L* defined in the L*a*b* color system of 70-90 (preferably 72-88, more preferably 75-85). The values of a* and b* defined in the L*a*b* color system each can be suitably selected according to the value of L*. For example, the values of a* and b* each are preferably in the range of from −10 to 10 (in particular, from −5 to 5), and each especially preferably are 0 or almost 0 (in the range of from −2 to 2).

In the invention, the values of L*, a*, and b* defined in the L*a*b* color system can be determined by a measurement with a color difference meter (trade name “CR-200”, manufactured by Minolta Ltd.; color difference meter). Incidentally, the L*a*b* color system is the color space recommended by the Commission Internationale de l'Eclairage (CIE) in 1976, and means the color space called CIE1976(L*a*b*) color system. In Japanese Industrial Standards, it is defined in accordance with JIS Z 8729.

The reflective layer in the invention may be any layer having reflecting properties. For example, the reflective layer may be a substrate, a rubbery organic elastic layer, or a pressure-sensitive adhesive layer, or may be any other desired layer such as a resin layer (e.g., a film layer), ink layer (e.g., a printed layer), or vapor-deposited metal layer. Preferred of these are a white substrate (white film substrate) and a white printed layer.

In the case where the reflective layer in the invention is a substrate, rubbery organic elastic layer, or pressure-sensitive adhesive layer, this reflective layer (e.g., reflective substrate) can be formed by incorporating a colorant corresponding to the color of the reflective layer when each layer described above is formed. In the case where the reflective layer is a white layer, a white colorant can, for example, be used as the colorant. In the case where the reflective layer is a silver layer, a silver colorant can, for example, be used. Although the white colorant and silver colorant may be any colorant (coloring agent) selected from pigments, dyes, etc., it is preferred to use pigments.

Examples of the white colorant include inorganic white colorants such as titanium oxides (titanium dioxides such as rutile titanium dioxide and anatase titanium dioxide), zinc oxide, aluminum oxide, silicon oxide, zirconium oxide, magnesium oxide, calcium oxide, tin oxide, barium oxide, cesium oxide, yttrium oxide, magnesium carbonate, calcium carbonate (e.g., lightweight calcium carbonate and heavy calcium carbonate), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc white, zinc sulfide, talc, silica, alumina, clay, kaolin, titanium phosphate, mica, gypsum, white carbon, diatomaceous earth, bentonite, lithopone, zeolites, sericite, and hydrated halloysite; and organic white colorants such as acrylic resin particles, polystyrene resin particles, polyurethane resin particles, amide resin particles, polycarbonate resin particles, silicone resin particles, urea-formalin resin particles, and melamine resin particles. A fluorescent brightener may be used as a white colorant. The fluorescent brightener can be suitably selected from known fluorescent brightness. Those white colorants can be used alone or in combination of two or more thereof.

Examples of the silver colorant include silver and aluminum. Such silver colorants can be used alone or in combination of two or more thereof.

In the case where the reflective layer in the invention is an ink layer, this reflective layer can be formed by applying an ink composition containing any of those white colorants or silver colorants and optionally containing a binder, dispersant, solvent, etc. (white ink composition or silver ink composition) to a support (e.g., substrate) and drying or curing the coating according to need.

The binder is not particularly limited. Examples thereof include known resins (e.g., thermoplastic resins, thermosetting resins, and photocurable resins) such as polyurethane resins, phenolic resins, epoxy resins, urea-melamine resins, silicone resins, phenoxy resins, methacrylic resins, acrylic resins, polyarylate resins, polyester resins (e.g., poly(ethylene terephthalate)), polyolefin resins (e.g., polyethylene, polypropylene, and ethylene/propylene copolymers), polystyrene resins (e.g., polystyrene, styrene/acrylonitrile copolymers, styrene/butadiene copolymers, styrene/maleic anhydride copolymers, and acrylonitrile/butadiene/styrene resins), poly(vinyl chloride), vinyl chloride/vinyl acetate copolymers, poly(vinyl acetate), poly(vinylidene chloride), polycarbonates, cellulose derivatives (e.g., cellulose acetate resins and ethyl cellulose resins), and polyacetals. Such binders can be used alone or in combination of two or more thereof. The solvent is suitably selected according to the kinds of the colorant and binder.

Examples of methods for forming the ink layer include known or common coating methods and methods using various printing techniques (e.g., gravure printing, flexographic printing, offset printing, letterpress printing, and screen printing).

In the case where the reflective layer is a resin layer (e.g., a film layer), this reflective layer can be formed by forming a resin composition prepared by mixing a resin with any of the white colorants or silver colorants into a sheet by a known or common sheet formation technique (e.g., extrusion molding, inflation molding, calendering, or solution casting) and laminating this sheet to another layer in the double-sided pressure-sensitive adhesive sheet.

Examples of the resin include polyesters (e.g., poly(ethylene terephthalate), poly(ethylene naphthalate), poly(butylene terephthalate), and poly(butylene naphthalate)), polyolefins (e.g., polyethylene, polypropylene, and ethylene/propylene copolymers), poly(vinyl alcohol), poly(vinylidene chloride), poly(vinyl chloride), vinyl chloride/vinyl acetate copolymers, poly(vinyl acetate), polyamides, polyimides, cellulose derivatives, fluororesins, polyethers, polystyrene resins (e.g., polystyrene), polycarbonates, and polyethersulfones. These resins may be used alone or in combination of two or more thereof.

The resin composition may contain known additives or ingredients according to need. Examples of the additives or ingredients include fillers, flame retardants, antioxidants, antistatic agents, softeners, ultraviolet absorbers, antioxidants, plasticizers, and surfactants.

In the case where the reflective layer in the invention is a silver layer, this reflective layer can be formed also by the vapor deposition of a metallic ingredient capable of having a silvery color, such as silver or aluminum. As the vapor deposition can be used vacuum vapor deposition, physical sputtering, chemical sputtering, or the like.

The reflective layer may have either a single-layer structure or a multilayer structure. However, it is preferred that the reflective layer have a multilayer structure from the standpoint of further enhancing reflecting properties. When the reflective layer has a multilayer structure, the number of layers in this reflective layer may be any number not smaller than 2. For example, the number thereof can be suitably selected in the range of 2-10, and is preferably 2-6 (more preferably 2-4, especially 2).

The thickness of the reflective layer (overall thickness of the reflective layer in the case where the reflective layer has a multilayer structure) is not particularly limited. For example, the thickness thereof can be selected in the range of 1-100 μm (preferably 5-50 μm). In the case where the reflective layer is a printed layer, the thickness thereof is preferably about 1-15 μm. In the case where the reflective layer is a vapor-deposited layer, it is preferred that the thickness thereof be, for example, about 0.3-2 μm (preferably 0.4-1 μm, more preferably 0.4-0.5 μm).

### Light-Shielding Layer

The light-shielding layer in the double-sided pressure-sensitive adhesive sheet of the invention is a layer which has the function of inhibiting the light emitted by a backlight from leaking out to the LCD surface to cause a visibility failure. The transmittance of the light-shielding layer in the invention is not particularly limited. However, the transmittance thereof is preferably 0.3(%) or lower (0-0.3(%)), more preferably 0.1(%) or lower (more preferably 0.05(%) or lower), especially preferably 0.03(%) or lower (in particular, 0.01(%) or lower).

In the invention, the light-shielding layer preferably is a black layer having a black color. The term black color as used for the black layer basically means a blackish color which has a value of L* defined in the L*a*b* color system of 35 or smaller (0-35, preferably 30 or smaller (0-30), more preferably 25 or smaller (0-25)). The values of a* and b* defined in the L*a*b* color system each can be suitably selected according to the value of L*. For example, the values of a* and b* each are preferably in the range of from −10 to 10 (in particular, from −5 to 5), and each especially preferably are 0 or almost 0 (in the range of from −2 to 2).

The light-shielding layer in the invention may be any layer having light-shielding properties. For example, the light-shielding layer may be a substrate, a rubbery organic elastic layer, or a pressure-sensitive adhesive layer, or may be any other desired layer such as a resin layer (e.g., a film layer) or an ink layer (e.g., a printed layer). Preferred of these are a black substrate (black film substrate) and a black printed layer.

The light-shielding layer in the invention can be formed in the same manner as for the reflective layer, except that a colorant having a black color is used as a colorant. As the colorant having a black color, use may be made of not only a black colorant but also a colorant mixture obtained by mixing two or more colorants selected from black colorants, cyan colorants (greenish-blue colorants), magenta colorants (purplish-red colorants), and yellow colorants.

The black colorants may be any colorants (coloring agents) selected from pigments, dyes, and the like. However, it is preferred to use pigments. Examples of the black colorants include carbon blacks (e.g., furnace black, channel black, acetylene black, thermal black, lamp black, and vegetable black), graphite, copper oxide, manganese dioxide, aniline black, perylene black, titanium black, cyanine black, activated carbon, ferrites (e.g., nonmagnetic ferrites and magnetic ferrites), magnetite, chromium oxide, iron oxide, molybdenum disulfide, chromium complexes, composite-oxide black pigments, and anthraquinone type organic black pigments. Such black colorants can be used alone or in combination of two or more thereof.

With respect to the cyan colorants, examples of pigments (cyan pigments) include C.I. Pigment Blue 1, 2, 3, 15, 15:1, 15:2, 15:3, 15:4, 15:5, 15:6, 16, 17, 17:1, 18, 22, 25, 56, 60, 63, 65, and 66; C.I. Vat Blue 4 and 60; and C.I. Pigment Green 7. Examples of dyes (cyan dyes) among the cyan colorants include C.I. Solvent Blue 25, 36, 60, 70, 93, and 95; and C.I. Acid Blue 6 and 45.

With respect to the magenta colorants, examples of pigments (magenta pigments) include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 42, 48:1, 48:2, 48:3, 48:4, 49, 49:1, 50, 51, 52, 52:2, 53:1, 54, 55, 56, 57:1, 58, 60, 60:1, 63, 63:1, 63:2, 64, 64:1, 67, 68, 81, 83, 87, 88, 89, 90, 92, 101, 104, 105, 106, 108, 112, 114, 122, 123, 139, 144, 146, 147, 149, 150, 151, 163, 166, 168, 170, 171, 172, 175, 176, 177, 178, 179, 184, 185, 187, 190, 193, 202, 206, 207, 209, 219, 222, 224, 238, and 245; C.I. Pigment Violet 3, 9, 19, 23, 31, 32, 33, 36, 38, 43, and 50; and C.I. Vat Red 1, 2, 10, 13, 15, 23, 29, and 35.

Examples of dyes (magenta dyes) among the magenta colorants include C.I. Solvent Red 1, 3, 8, 23, 24, 25, 27, 30, 49, 52, 58, 63, 81, 82, 83, 84, 100, 109, 111, 121, and 122; C.I. Disperse Red 9; C.I. Solvent Violet 8, 13, 14, 21, and 27; C.I. Disperse Violet 1; C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

With respect to the yellow colorants, examples of pigments (yellow pigments) include C.I. Pigment Orange 31 and 43; C.I. Pigment Yellow 1, 2, 3, 4, 5, 6, 7, 10, 11, 12, 13, 14, 15, 16, 17, 23, 24, 34, 35, 37, 42, 53, 55, 65, 73, 74, 75, 81, 83, 93, 94, 95, 97, 98, 100, 101, 104, 108, 109, 110, 113, 114, 116, 117, 120, 128, 129, 133, 138, 139, 147, 150, 151, 153, 154, 155, 156, 167, 172, 173, 180, 185, and 195; and C.I. Violet Yellow 1, 3, and 20. Examples of dyes (yellow dyes) among the yellow colorants include C.I. Solvent Yellow 19, 44, 77, 79, 81, 82, 93, 98, 103, 104, 112, and 162.

In the colorant mixture, the blending ratio (proportions) among the cyan colorant, magenta colorant, and yellow colorant is not particularly limited so long as the colorant mixture can have a blackish color. For example, the contents of these colorants can be suitably selected from the following ranges of contents based on the total amount of the colorants; cyan colorant/magenta colorant/yellow colorant=10-50% by weight/10-50% by weight/10-50% by weight (preferably, 20-40% by weight/20-40% by weight/20-40% by weight). A black colorant may be mixed according to need.

In the invention, the light-shielding layer may have either a single-layer structure or a multilayer structure. However, it is preferred that the light-shielding layer should have a multilayer structure. By thus employing a light-shielding layer having a multilayer structure, even higher light-shielding properties can be imparted to the light-shielding layer. When the light-shielding layer has a multilayer structure, the number of layers in this light-shielding layer may be any number not smaller than 2. For example, the number thereof can be suitably selected in the range of 2-10, and is preferably 3-8 (more preferably 4-6, especially 4). Furthermore, the light-shielding layer may be a black film layer having a multilayer structure constituted of: a film layer formed from a cyan ink composition mainly containing a cyan colorant; a film layer formed from a magenta ink composition mainly containing a magenta colorant; and a film layer formed from a yellow ink composition mainly containing a yellow colorant.

The thickness of the light-shielding layer (overall thickness of the light-shielding layer in the case where the light-shielding layer has a multilayer structure) is not particularly limited. For example, the thickness thereof can be selected in the range of 1-100 μm (preferably 5-50 μm). In the case where the light-shielding layer is a printed layer (light-shielding printed layer), the thickness of this light-shielding printed layer is preferably 1-15 μm.

### Double-Sided Pressure-Sensitive Adhesive Sheet

In the double-sided pressure-sensitive adhesive sheet of the invention, the heat-peelable pressure-sensitive adhesive layer may be formed not only on one side of a substrate but also on each side thereof. The rubbery organic elastic layer also may be disposed on one side or on each side of the substrate according to need. Furthermore, an interlayer such as an undercoat layer or an adhesive layer may be formed, for example, between the rubbery organic elastic layer and the heat-peelable pressure-sensitive adhesive layer, besides the reflective layer and the light-shielding layer.

Preferred examples of the layer constitution of the double-sided pressure-sensitive adhesive sheet of the invention include: (1) a single-layer of heat-peelable pressure-sensitive adhesive layer (light-shielding heat-peelable pressure-sensitive adhesive layer); (2) heat-peelable pressure-sensitive adhesive layer/rubbery organic elastic layer/black substrate (light-shielding substrate)/pressure-sensitive adhesive layer containing no heat-expandable microsphere; (3) heat-peelable pressure-sensitive adhesive layer/rubbery organic elastic layer/black substrate (light-shielding substrate)/white substrate (reflective substrate)/pressure-sensitive adhesive layer containing no heat-expandable microsphere; (4) heat-peelable pressure-sensitive adhesive layer/rubbery organic elastic layer/black substrate (light-shielding substrate)/white substrate (reflective substrate)/rubbery organic elastic layer/heat-peelable pressure-sensitive adhesive layer; (5) pressure-sensitive adhesive layer containing no heat-expandable microsphere/heat-peelable pressure-sensitive adhesive layer/rubbery organic elastic layer/substrate/pressure-sensitive adhesive layer containing no heat-expandable microsphere; and (6) pressure-sensitive adhesive layer containing no heat-expandable microsphere/heat-peelable pressure-sensitive adhesive layer/rubbery organic elastic layer/substrate/rubbery organic elastic layer/heat-peelable pressure-sensitive adhesive layer/pressure-sensitive adhesive layer containing no heat-expandable microsphere. However, the invention should not be construed as being limited to these constitutions. Especially preferred of these is the layer constitution (3).

The double-sided pressure-sensitive adhesive sheet of the invention is used for fixing a liquid-crystal display module unit to a backlight unit in a liquid-crystal display (LCD) (in particular, a small liquid-crystal display) for use in cell phones, personal digital assistants (PDAs), small game machine, etc. In particular, it is preferred to use the double-sided pressure-sensitive adhesive sheet in LCDs of the lighting/external-light dual type.

### Separator

The double-sided pressure-sensitive adhesive sheet of the invention may have a separator (release liner) disposed on a pressure-sensitive adhesive layer surface from the standpoints of protecting the pressure-sensitive adhesive layer surface, preventing blocking, etc. The separator is to be peel off when the pressure-sensitive adhesive sheet is applied to an adherend, and need not be always disposed. The separator to be used is not particularly limited, and a known or common release paper or the like can be used. For example, use may be made of: a substrate having a release layer, such as a plastic film or paper having a surface treated with a releasant such as a silicone, long-chain alkyl type releasant, fluorochemical, or molybdenum sulfide; a lowly bondable substrate made of a fluoropolymer such as polytetrafluoroethylene, polychlorotrifluoroethylene, poly(vinyl fluoride), poly(vinylidene fluoride), a tetrafluoroethylene/hexafluoropropylene copolymer, or a chlorofluoroethylene/vinylidene fluoride copolymer; or a lowly bondable substrate made of a nonpolar polymer such as an olefin resin (e.g., polyethylene or polypropylene). In the case where the double-sided pressure-sensitive adhesive sheet of the invention is of the substrate-less type, the separator functions as a supporting substrate for the pressure-sensitive adhesive layer.

The separator may be disposed on each of both surfaces of the double-sided pressure-sensitive adhesive sheet of the invention. Alternatively, use may be made of a method in which a separator having a back-side release layer is disposed on the pressure-sensitive adhesive surface on one side and this sheet is rolled to thereby bring the back-side release layer of the separator into contact with the pressure-sensitive adhesive surface on the opposite side.

### Liquid-Crystal Display

The liquid-crystal display of the invention is fabricated by fixing a liquid-crystal display module unit to a backlight unit with the double-sided pressure-sensitive adhesive sheet described above. FIG. 3 is a diagrammatic view illustrating an arrangement of the liquid-crystal display module unit, backlight unit, and double-sided pressure-sensitive adhesive sheet in a liquid-crystal display according to the invention. This liquid-crystal display of the invention includes a backlight unit 6, a double-sided pressure-sensitive adhesive sheet 7 of the invention which has been processed into an architrave form and bonded to the backlight unit 6, and a liquid-crystal display module unit 8 bonded and fixed to the adhesive sheet 7. In the case where a surface layer on only either side of the double-sided pressure-sensitive adhesive sheet is a heat-peelable pressure-sensitive adhesive layer, the heat-peelable pressure-sensitive adhesive layer may be applied to either of the liquid-crystal display module unit and the backlight unit. It is preferred to dispose the double-sided pressure-sensitive adhesive sheet so that the member which is especially desired to be recovered faces the heat-peelable pressure-sensitive adhesive layer.

In the liquid-crystal display of the invention, the liquid-crystal display module unit and the backlight unit have been fixed to each other through a heat-peelable pressure-sensitive adhesive layer. Because of this, when the liquid-crystal display module unit and backlight unit once fixed are desired to be disassembled (separated), the adhesive force of the heat-peelable pressure-sensitive adhesive layer can be reduced by heating. As a result, the two units can be easily separated/disassembled without imposing a stress to these units. Examples of such cases where the liquid-crystal display module unit and backlight unit once fixed are disassembled include: the case where the double-sided pressure-sensitive adhesive sheet has been applied in a wrong position; the case where the liquid-crystal display module unit, backlight unit, or double-sided pressure-sensitive adhesive sheet has a failure such as an optical defect; the case where a foreign matter has come during the fixing of the liquid-crystal display module unit to the backlight unit; and the case where an LCD which has been used is recovered/disassembled.

Conditions for the heat treatment for making the double-sided pressure-sensitive adhesive sheet of the invention easily peelable from the adherend can be suitably determined according to the property of decreasing in adhesion area, which depends on the surface state of the adherend, kind of the heat-expandable microspheres, etc., and to other factors including the heat resistance of the substrate and adherend and the method of heating. Examples of methods for the treatment generally include a method in which a technique of heating with a hot-air drying oven or the like as a heat source is used to conduct the treatment at a temperature of 90-100° C. for 10-300 seconds. Upon heating under such conditions, the heat-expandable microspheres in the heat-peelable pressure-sensitive adhesive layer expand and/or foam. As a result, the pressure-sensitive adhesive layer expands/deforms, and the adhesive force thereof is reduced or lost.

The liquid-crystal display of the invention is useful as the liquid-crystal displays of cell phones, personal digital assistants (PDAs), digital cameras, portable small personal computers, portable game machines, liquid-crystal TVs, and navigation systems for motor vehicles, etc.

### Methods of Determining Properties and Methods of Evaluating Effects

The determination methods and effect evaluation methods used in the invention are exemplified below.

(1) Ordinary Adhesive Force

A poly(ethylene terephthalate) (PET) film having a thickness of 25 μm (“Lumirror #25 S-10”, manufactured by Toray Industries, Inc.) was applied (as a backing) to the pressure-sensitive adhesive surface on the side opposite to the heat-peelable pressure-sensitive adhesive layer side in each of the double-sided pressure-sensitive adhesive sheets obtained in the Examples and Comparative Example. Thus, samples for adhesive force measurement (width: 20 mm) were produced.

Each sample was examined for adhesive force by the 180° peeling method in accordance with JIS Z 0237. Under the conditions of 23° C. and 50% RH, the heat-peelable pressure-sensitive adhesive layer of each sample was applied to an adherend (test plate: stainless-steel plate) and allowed to stand for 30 minutes. Using a tensile tester (“Tensile/compression Tester TG-1kN”; Minebea Co., Ltd.), the sample was peeled off under the conditions of a peel angle of 180° and a peel rate of 300 mm/min. The load required for this peeling was measured and taken as ordinary adhesive force (N/20 mm).

(2) Lifting of Liquid-Crystal Module Unit

An architrave shape having outer dimensions of 38 mm×55 mm and a width of 2 mm was punched out of each of the double-sided pressure-sensitive adhesive sheets obtained in the Examples and Comparative Example.

Using the architrave-form double-sided pressure-sensitive adhesive sheet, a liquid-crystal module unit (size: 38 mm×55 mm) was laminated to a backlight unit (size: 40 mm×57 mm) so that the heat-peelable pressure-sensitive adhesive layer was in contact with the liquid-crystal module. Thus, a liquid-crystal display was obtained.

The liquid-crystal display was allowed to stand in a 70° C. atmosphere for 500 hours and then visually examined for the “lifting” of the liquid-crystal module unit from the backlight unit.

(3) Peelability of Liquid-Crystal Module Unit

A liquid-crystal display obtained in the same manner as in (2) above was allowed to stand at 23° C. and 50% RH for 24 hours and then heat-treated with a 100° C. hot-air drying oven for 5 minutes. Thereafter, the liquid-crystal module unit was manually peeled to visually examine the peelability of the liquid-crystal module unit.

(4) Method of Determining L*, a*, and b*

The values of L*, a*, and b* defined in the L*a*b* color system were determined with a color difference meter (apparatus name “CR-200”, manufactured by Konica Minolta Inc.).

(5) Reflectance

A spectrophotometer (apparatus name “MPS-2000”, manufactured by Shimadzu Corp.) is used to irradiate the reflective-layer side of a reflective light-shielding member with a light having a wavelength of 550 nm, and the intensity of the light reflected by the irradiated surface is measured to determine the reflectance (%) thereof.

(6) Transmittance

A spectrophotometer (apparatus name “Spectrophotometer Type U4100”, manufactured by Hitachi Ltd.) is used to irradiate a reflective light-shielding member with a light having a wavelength of 550 nm from one side of the member, and the intensity of the light transmitted to the other side is measured. Thus, the transmittance (%) thereof is determined.

### Examples

The invention will be explained below in more detail by reference to Examples, but the invention should not be construed as being limited by these Examples. The results of evaluation obtained in the Examples and Comparative Example are given in Table 1.

### Example 1

(Pressure-Sensitive Adhesive Layer Containing No Heat-Expandable Microsphere)

To 100 parts by weight of a copolymer obtained from butyl acrylate/acrylic acid/hydroxyethyl acrylate (100 parts by weight/5 parts by weight/1 part by weight) were added 2 parts by weight of an isocyanate crosslinking agent (“Coronate L”, manufactured by Nippon Polyurethane Co., Ltd.) and 40 parts by weight of a terpene-phenol tackifier resin (“Sumilite Resin PR12603”, manufactured by Sumitomo Bakelite Co., Ltd.). Thereto was added 400 parts by weight of toluene to prepare a uniformly mixed solution (Solution 1). Subsequently, Solution 1 was applied, in a thickness of 20 μm on a dry basis, to a surface of a PET substrate having a black layer formed thereon by printing (manufactured by Daisan Films Converting Co., Ltd.; 12-μm PET; 3-pass black solid printing). Thus, a pressure-sensitive adhesive layer containing no heat-expandable microsphere was formed.

(Rubbery Organic Elastic Layer)

Solution 1 was applied, in a thickness of 20 μm on a dry basis, to that side of the substrate having the pressure-sensitive adhesive layer formed thereon which was opposite to the pressure-sensitive adhesive layer. Thus, a rubbery organic elastic layer was formed.

(Heat-Peelable Pressure-Sensitive Adhesive Layer)

To 100 parts by weight of the copolymer were added 7 parts by weight of an isocyanate crosslinking agent (“Coronate L”, manufactured by Nippon Polyurethane Co., Ltd.) and 50 parts by weight of heat-expandable microspheres (“Microsphere F30D”, manufactured by Matsumoto Yushi-Seiyaku Co., Ltd.). Thereto was added 400 parts by weight of toluene to prepare a uniformly mixed solution (Solution 2). Subsequently, Solution 2 was applied to a PET-based separator (manufactured by Toray Advanced Film Co., Ltd.; 38 μm) in a thickness of 30 μm on a dry basis and dried. Thus, a heat-peelable pressure-sensitive adhesive layer was formed.

(Double-Sided Pressure-Sensitive Adhesive Sheet)

The sheet obtained above which was composed of pressure-sensitive adhesive layer containing no heat-expandable microsphere/PET substrate/rubbery organic elastic layer was laminated to the separator having the heat-peelable pressure-sensitive adhesive layer, so that the rubbery organic elastic layer was in contact with the heat-peelable pressure-sensitive adhesive layer. Thus, a double-sided pressure-sensitive adhesive sheet (covered with a separator) having a light-shielding layer was obtained.

### Example 2

Solution 1 obtained in Example 1 was applied, in a thickness of 20 μm on a dry basis, to each side of a PET substrate having a black layer formed thereon by printing (manufactured by Daisan Films Converting Co., Ltd.; 12-μm PET; 3-pass black solid printing). Thus, rubbery organic elastic layers were formed.

To 100 parts by weight of the copolymer used in Example 1 were added 7 parts by weight of an isocyanate crosslinking agent (same as in Example 1) and 70 parts by weight of heat-expandable microspheres (same as in Example 1). Thereto was added 450 parts by weight of toluene to prepare a uniformly mixed solution (Solution 3). Subsequently, Solution 3 was applied to a PET-based separator (same as in Example 1) in a thickness of 30 μm on a dry basis and dried. Thus, a heat-peelable pressure-sensitive adhesive layer was formed.

The separator having the heat-peelable pressure-sensitive adhesive layer was laminated to each side of the sheet obtained above which was composed of rubbery organic elastic layer/PET substrate/rubbery organic elastic layer, so that each rubbery organic elastic layer was in contact with the heat-peelable pressure-sensitive adhesive layer. Thus, a double-sided pressure-sensitive adhesive sheet (covered with separators) having a light-shielding layer was obtained.

### Example 3

To 100 parts by weight of the copolymer used in Example 1 were added 4 parts by weight of an isocyanate crosslinking agent (“Coronate L”, manufactured by Nippon Polyurethane Co., Ltd.), 25 parts by weight of a terpene-phenol tackifier resin (“Sumilite Resin PR12603N”, manufactured by Sumitomo Bakelite Co., Ltd.), 50 parts by weight of heat-expandable microspheres (“Microsphere F30D”, manufactured by Matsumoto Yushi-Seiyaku Co., Ltd.), and 1 part by weight of a black pigment (“PASTE BLACK R-2292B”, manufactured by Dainippon Ink & Chemicals, Inc.). Thereto was added 450 parts by weight of toluene. The ingredients were evenly mixed to produce a solution. This toluene solution was applied to a PET-based separator (same as in Example 1) in a thickness of 20 μm on a dry basis (heat-peelable pressure-sensitive adhesive layer 1). Subsequently, the same toluene solution was applied to a release paper (about 120 μm; “SL-80 KCTX”, manufactured by Kaito Chemical Industry Co., Ltd.) in a thickness of 20 μm on a dry basis, and then laminated to the heat-peelable pressure-sensitive adhesive layer 1 to obtain a double-sided pressure-sensitive adhesive sheet (covered with separators).

### Example 4

Solution 1 obtained in Example 1 was applied, in a thickness of 20 μm on a dry basis, to each side of a PET substrate obtained by forming a black layer on a white film substrate by printing (“TU #13 Solid Printing 5P”, manufactured by Daisan Films Converting Co., Ltd.). Thus, rubbery organic elastic layers were formed.

Subsequently, Solution 3 obtained in Example 2 was applied to a PET-based separator (same as in Example 1) in a thickness of 30 μm on a dry basis to obtain a heat-peelable pressure-sensitive adhesive layer.

The separator having the heat-peelable pressure-sensitive adhesive layer was laminated to each side of the sheet obtained above which was composed of rubbery organic elastic layer/PET substrate/rubbery organic elastic layer, so that each rubbery organic elastic layer was in contact with the heat-peelable pressure-sensitive adhesive layer. Thus, a double-sided pressure-sensitive adhesive sheet (covered with separators) having a reflective layer and a light-shielding layer was obtained.

### Comparative Example 1

Solution 1 obtained in Example 1 was applied, in a thickness of 20 μm on a dry basis, to each side of a PET substrate having a black layer formed thereon by printing (manufactured by Daisan Films Converting Co., Ltd.; 12-μm PET; 3-pass black solid printing) to form pressure-sensitive adhesive layers containing no heat-expandable microsphere.

Thus, a double-sided pressure-sensitive adhesive sheet was obtained without forming a heat-peelable pressure-sensitive adhesive layer.

TABLE 1

| | Ordinary | Lifting of | Peelability of |
|---|---|---|---|
| | adhesive force | liquid-crystal | liquid-crystal |
| | (N/20 mm) | module unit | module unit |
| Example 1 | 11.2 | good | good |
| | | (no lifting) | (satisfactory peelability) |
| Example 2 | 10.8 | good | good |
| | | (no lifting) | (satisfactory peelability) |
| Example 3 | 9.8 | good | good |
| | | (no lifting) | (satisfactory peelability) |
| Example 4 | 10.0 | good | good |
| | | (no lifting) | (satisfactory peelability) |
| Comparative | 13.5 | good | poor |
| Example 1 | | (no lifting) | (glass breakage occurred in |
| | | | liquid-crystal unit) |

Table 1 shows the followings. The double-sided pressure-sensitive adhesive sheets of the invention (Examples 1 to 4) had excellent adhesive force in the ordinary state and caused no “lifting” even in standing in a 70° C. atmosphere. Furthermore, the double-sided pressure-sensitive adhesive sheets, through a heat treatment, made the liquid-crystal module units peelable without being damaged.

In contrast, in the case of the double-sided pressure-sensitive adhesive sheet which did not have the heat-peelable pressure-sensitive adhesive layer according to the invention (Comparative Example 1), the liquid-crystal module unit received a high stress during the peeling operation and suffered glass breakage.

While the present invention has been described in detail and with reference to specific embodiments thereof, it will be apparent to one skilled in the art that various changes and modifications can be made therein without departing from the scope thereof.

This application is based on Japanese patent application No. 2006-336075 filed Dec. 13, 2006, the entire contents thereof being hereby incorporated by reference.

Further, all references cited herein are incorporated in their entireties.

### INDUSTRIAL APPLICABILITY

According to the double-sided pressure-sensitive adhesive sheet of the invention, since the pressure-sensitive adhesive layer has high adhesiveness and a liquid-crystal display module unit can be tenaciously fixed to a backlight unit with the pressure-sensitive adhesive sheet, excellent adhesion reliability can be attained. Furthermore, since this pressure-sensitive adhesive sheet can be easily made peelable by a heat treatment, it has excellent suitability for reworking.

1. A double-sided pressure-sensitive adhesive sheet for use in fixing a liquid-crystal display module unit to a backlight unit in a liquid-crystal display, the double-sided pressure-sensitive adhesive sheet comprising at least one heat-peelable pressure-sensitive adhesive layer containing heat-expandable microspheres.

2. The double-sided pressure-sensitive adhesive sheet according to claim 1, which comprises the heat-peelable pressure-sensitive adhesive layer containing heat-expandable microspheres as one outermost layer and further comprises a pressure-sensitive adhesive layer containing no heat-expandable microsphere as the other outermost layer.

3. The double-sided pressure-sensitive adhesive sheet according to claim 1, which further comprises a substrate, and wherein the heat-peelable pressure-sensitive adhesive layer containing heat-expandable microspheres is disposed as the outermost layer on each side of the substrate.

4. The double-sided pressure-sensitive adhesive sheet according to claim 1, which further comprises a substrate and a rubbery organic elastic layer disposed between the substrate and the heat-peelable pressure-sensitive adhesive layer.

5. The double-sided pressure-sensitive adhesive sheet according to any one of claims 1 to 4, which has a light-shielding layer and/or a reflective layer.

6. The double-sided pressure-sensitive adhesive sheet according to claim 5, wherein the light-shielding layer and/or the reflective layer is the substrate, the rubbery organic elastic layer, the pressure-sensitive adhesive layer, or any other desired layer.

7. The double-sided pressure-sensitive adhesive sheet according to claim 6, wherein the reflective layer is a white substrate or a white printed layer.

8. The double-sided pressure-sensitive adhesive sheet according to claim 6, wherein the light-shielding layer is a black substrate or a black printed layer.

9. A liquid-crystal display, which comprises a liquid-crystal display module unit and a backlight unit fixed with the double-sided pressure-sensitive adhesive sheet according to claim 1.
